(19) United States
(12) Patent Application Publication
(10) Pub. No.: US 2008/0083309 A1
(43) Pub. Date: Apr. 10, 2008

(54) Blister pack opening tool

(76) Inventor: Jeffery Lothian, Delray Beach, FL (US)

Correspondence Address: JUAN C. VILLAR, 9365 AEGEAN DRIVE, BOCA RATON, FL, 33496, US

(21) Appl. No.: 11/544,996

(22) Filed: Oct. 6, 2006

(51) Int. Cl. B26B 3/00

(52) U.S. Cl. 83/15; 30/140

(57) ABSTRACT

Disclosed is a tool for opening blister packs having a casing for handheld operation, a heatable cutting tip, a heating element in electrical contact with a power supply capable of bringing the operating temperature of the heating tip to no less than 380° F. and wherein the heating tip is configured to Cut through the blister pack when heated to operating temperature.

### BACKGROUND OF THE INVENTION

1. Field of the Invention

This disclosure relates to an apparatus and method for opening clamshell blister packs.

2. Description of the Art

Plastic packaging has become commonplace in the marketplace, particularly that type known as blister packs. Traditional blister packaging consists of a formed clear plastic cover bonded to a cardboard backing. However, these cardboard-backed blister packs are subject to infiltration and theft in the stores in which they are displayed.

Increasingly, manufactures are now moving toward “clamshell,” or double-sided blister packs. In these packs, both sides of the packaging are of a clear plastic and are bonded together tightly, making them extremely difficult to open. In fact they generally cannot be opened without the use of a knife or scissors because they are usually made of clear polyvinyl chloride (PVC), which is a very tough material formed by adding plasticizers, such as phthalate esters to pure PVC. Not only does this deter theft, but also affords greater protection to the packaged product during shipping.

For the remainder of this specification, the term “blister pack” will be used to describe clamshell blister packs for the convenience of the reader.

Heavier gauge blister packs are so difficult to cut open that even scissors will not do. In these cases, a knife, such as box cutters, must be used. Because the plastic cover is formed from a mold, and therefore non-homogenous, there will be portions of the blister pack that are easier to cut through than others. The edges of the blister pack are particularly difficult to cut through. The danger to the consumer when using a sharp blade is that the consumer will exert great force to cut through these difficult portions and then, when breaking through, will find the blade moving so fast that he may cut himself.

In fact, The Center for Disease Control in Atlanta reported that in 2001, unintentional cuts and piercings were the fifth most common cause of nonfatal injuries. In an article by Steve Friess appearing in the May 22, 2006, issue of Wired News, entitled Tales From Packaging Hell. Friess writes that surgeons report such injuries about once a week during the year, with a huge increase in the week following Christmas, some involving serious nerve and tendon damage.

What is needed is a safe and effective way to open blister packs

### BRIEF SUMMARY OF THE DISCLOSURE

Disclosed is a tool for opening blister packs having a casing for handheld operation, a heatable cutting tip, a heating element in electrical contact with a power supply capable of bringing the operating temperature of the heating tip to no less than 380° F., and wherein the heating tip is configured to cut through the blister pack when heated to operating temperature.

The heatable cutting tip may be heated by any known means, including positive temperature coefficient heating elements or athalite elements.

The heatable cutting tip may have acute features to aid in cutting, such as a pointed or blade configuration.

Also disclosed is a method of opening blister packs, comprising the steps of heating a cutting tip to a temperature of at least 380° F., and applying the cutting tip to a blister pack.

### BRIEF DESCRIPTION OF THE DRAWINGS

FIG. 1 shows a cross-sectional view of a first embodiment of invention.

FIG. 1B shows a side view of an embodiment of a cutting blade of the invention.

FIG. 2 shows a cross-sectional view of a retractable embodiment of the invention.

FIG. 3 is a top view cross-sectional embodiment of the cutting tips of the embodiments of FIGS. 1 and 2 displaying a longitudinal cutting edge configuration.

FIG. 4 shows a cross-section view of a graphite or graphite-alloy cutting tip embodiment of the invention.

FIG. 5 shows another embodiment of a graphite or graphite-alloy cutting tip of the invention.

FIG. 6 is a top view cross-sectional embodiment of the cutting tips of the embodiments of FIGS. 4 and 5 displaying a longitudinal cutting edge configuration.

### DETAILED DESCRIPTION OF PREFERRED EMBODIMENTS

The present invention is useful for easily and conveniently opening blister packs and reducing risk of injury from doing same. The basic principle is to provide and use a device that has a hot cutting edge, hot enough to melt the plastic from which the blister pack is constructed. The vast majority of blister packs are made from clear polyvinyl chloride (PVC), which generally begins to melt at about 380° F. However, 380° F. is a slow melt, so it is anticipated that the invention will be used at higher temperatures so as to cut through clear PVC more quickly, Such as temperatures above 480°, preferably at least 800° F.

As stated above, for the purposes of this specification, “blister pack” refers to clamshell blister packs, as opposed to cardboard-backed blister packs.

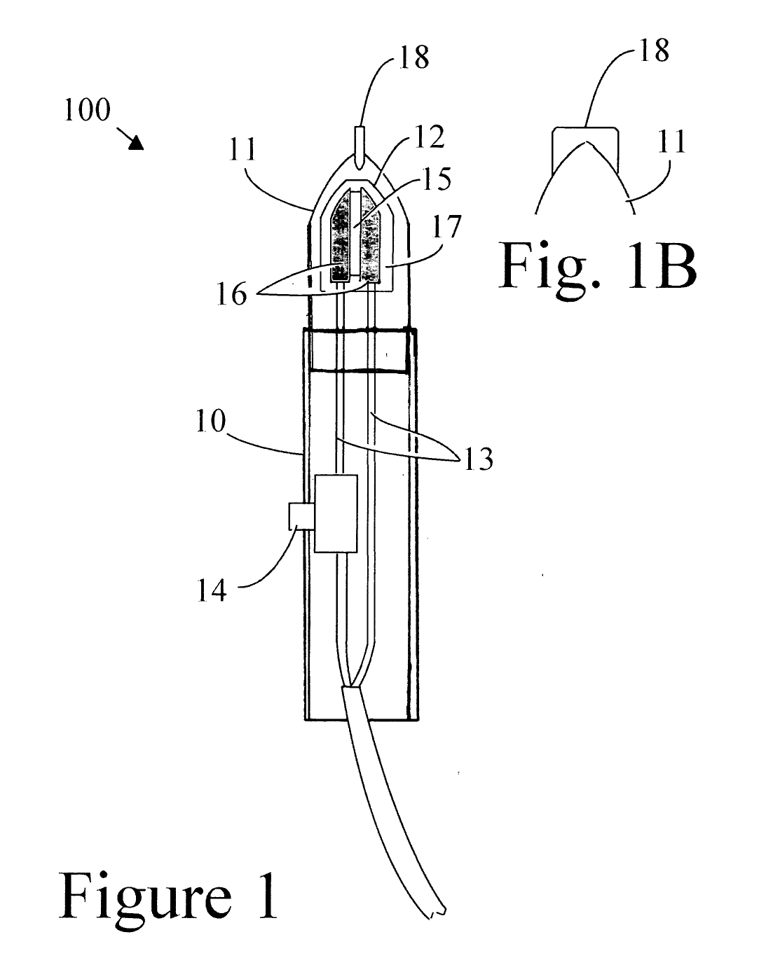

Referring to FIG. 1. there is shown a first embodiment of the opening tool 100 of the invention having a heatable cutting tip 11 supported in a casing 10. The heatable cutting tip 11 is made of a heat conductive material, such as copper or aluminum and may optionally have a blade 18 incorporated into it's design, a side view of which is shown in FIG. 1B. The casing 10 is made of a heat insulating material, such as thermoplastic, to protect the user from heat generated at the heatable cutting tip 11. Within the heatable cutting tip 11 is a heating element 12, which may be any suitable heating element. The heating element is connected to a power supply (not shown) via a set of electrical wires 13 and a switch 14. The power supply may be AC or DC.

A preferred heating element is a positive temperature coefficient (PTC) type of heating element as shown in the drawing, though traditional heating elements, such a resistive coils may be used. The PTC heating element, however, has the advantage of heating quickly and not requiring any temperature regulating circuitry.

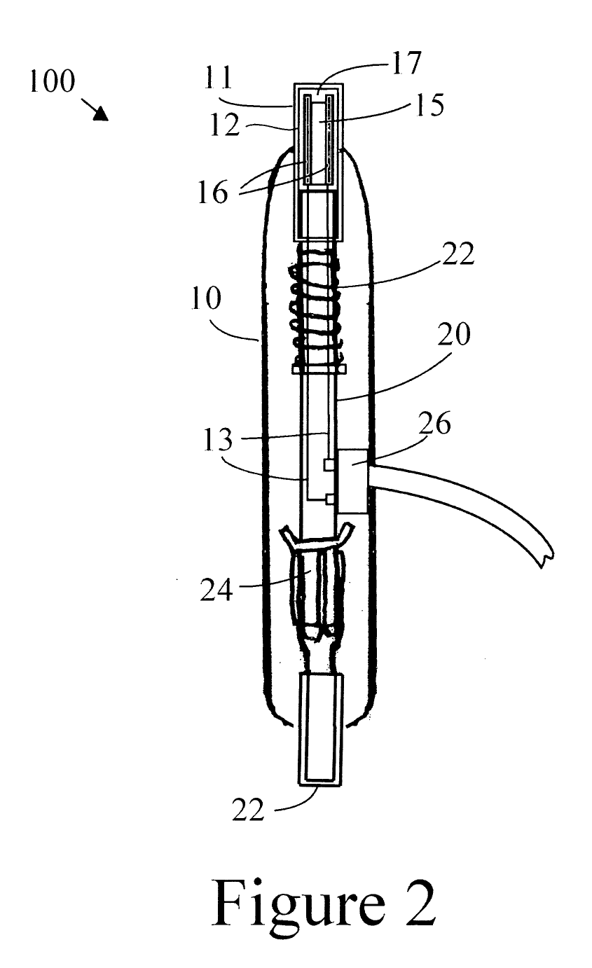

As shown in FIGS. 1 and 2, the PTC heating element 12 comprises a ceramic PTC element 15 sandwiched between a pair of electrodes. The ceramic is a doped polycrystalline ceramic, usually barium titanate, and is therefore semiconductive in nature. As can be seen in the following graph, when current is initially applied the resistance of the ceramic first drops somewhat with increasing temperature. Hence, the device is initially shows a somewhat negative temperature coefficient which accelerates the heating of the ceramic. After reaching a minimum resistance point, R_{MIN}, the temperature coefficient goes positive, causing the R vs. T curve to shoot upwards. Hence at this part of the curve the resistance of the PTC element rises rapidly with temperature, causing the element to be self limiting. The PTC element quickly reaches equilibrium at a reference temperature, T_{REF} without need for any special regulating circuitry. One need only connect a power supply to the electrodes that can supply enough current to bring the PTC to the reference temperature. It does not matter whether the current is AC or DC.

The reference temperature of the PTC element 15 is based upon how the ceramic is doped and is therefore controllable at manufacture.

To prevent the electrodes from being shorted out by a metal heatable cutting tip 11, it is necessary for the heating element 12 to have an insulative encapsulation 17 that can withstand high temperatures, such as a high temperature carbon-based of silicon based polymer. However, while this encapsulation must be electrically insulative, it is desired that it be as thermally conductive as is practical. This is typically achieved by permeating the encapsulation material with a metal oxide. Iron oxide and aluminum oxide are generally the most cost effective, though just about any metal oxide is effective.

Referring to FIG. 2 is a “clickable pen” embodiment of the opening tool 100, having a heatable cutting tip 11 attached to a shaft 20 slideably mounted within the casing 10 and spring-loaded with a spring 22. The operation of the device is just like any click-pen, pressing on the button 22 causes a cam 24, common in the pen art, to alternately retract and extend the heatable cutting tip 11 through an opening at the tip of the casing 10. The electrode wires 13 in this case may be operated by a separate switch as in FIG. 1, but a desired alternative is to have them engage with switch 26 so as to turn the heating element 12 on when the heatable cutting tip 11 is extended and to shut the heating element 12 off when the heatable cutting tip 11 is retracted.

The shape of the heatable cutting tip 11 may be closely fitted to the opening at the tip of the casing 10 so as to strip off any molten plastic clinging to the heatable cutting tip 11 when retracted.

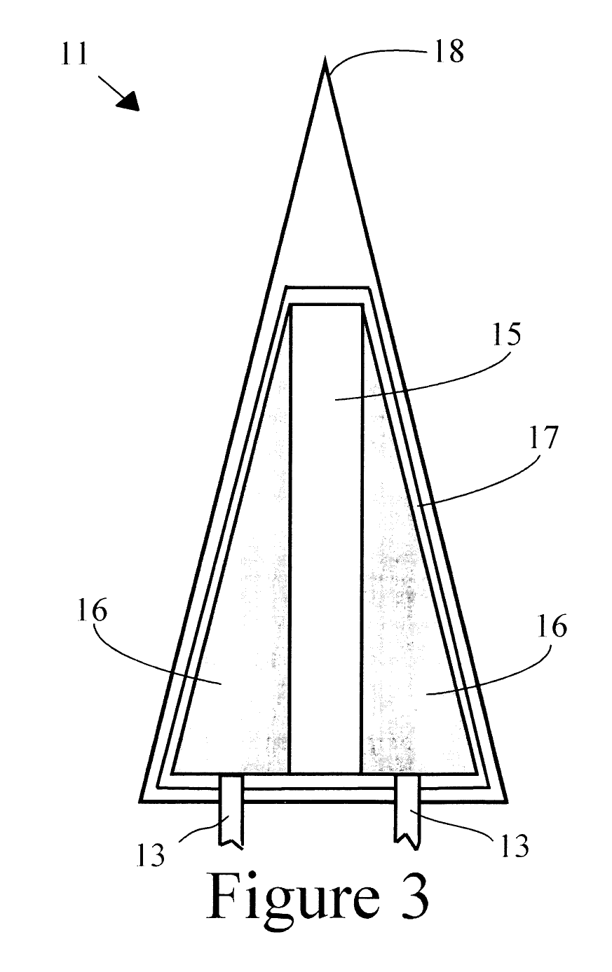

Referring to FIG. 3 there is shows an embodiment of a heatable cutting tip 11 that may be adapted to any of the aforementioned embodiments. Here, the PTC ceramic element 15 is sandwiched between electrodes that closely fit to a conical or wedge shaped heatable cutting tip 11 having a relatively sharpened tip 18, though preferably not so sharp as to present a danger of injuring the user should the tool slip.

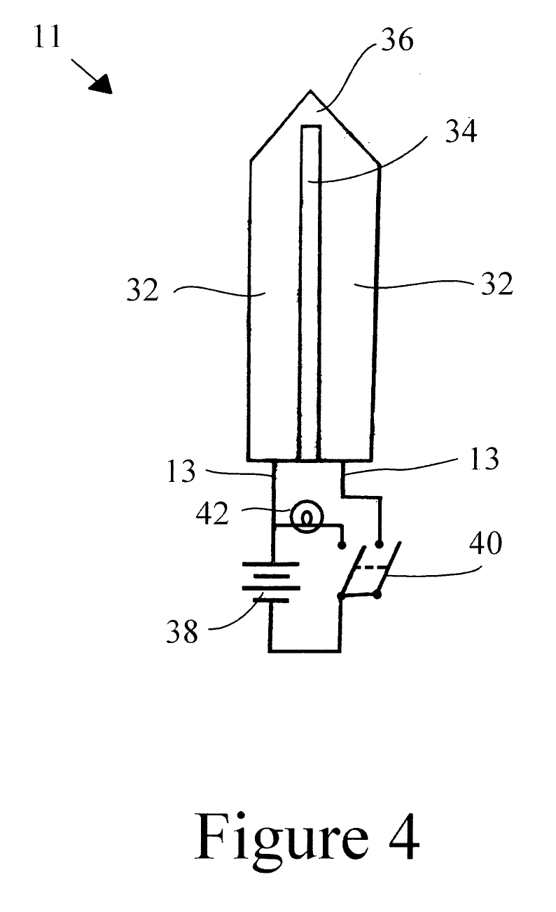

FIG. 4 shows an athalite embodiment of a heatable cutting tip 11 of the opening tool. Athalite is a proprietary material used in soldering tools currently sold under the tradename ColdHeat. Athalite comprises graphite and may further comprise other materials such as germanium or silicon, as described in U.S. Pat. No. 6.646,228, the disclosures of which are incorporated by reference herein in their entirety. Athalite heats up very rapidly to high temperatures when current is applied and then cools within moments when current is cut off. With a handful of AA batteries, temperatures of 600° F. may be attained within a few seconds.

Typically, the resistivity of the athalite will be at least 1,500 microOhm-cm, preferably at least 3,000 microOhm-cm, with a thermal conductivity of less than 10 BTU/hr-ft-° F. The athalite should also have a density in excess of 1.5 grams/cc.

As seen in the Figure two athalite electrodes 32 are provided, separated by an insulator 34, such as mica. The athalite electrodes 32 are connected at the tip of the tool by a conductive bridge 36, which may also be made of athalite. A DC or AC power source 38 provides power through electrode wires 13 via a switch 40. An indicator lamp may be provided to warn the user when the opening tool is active.

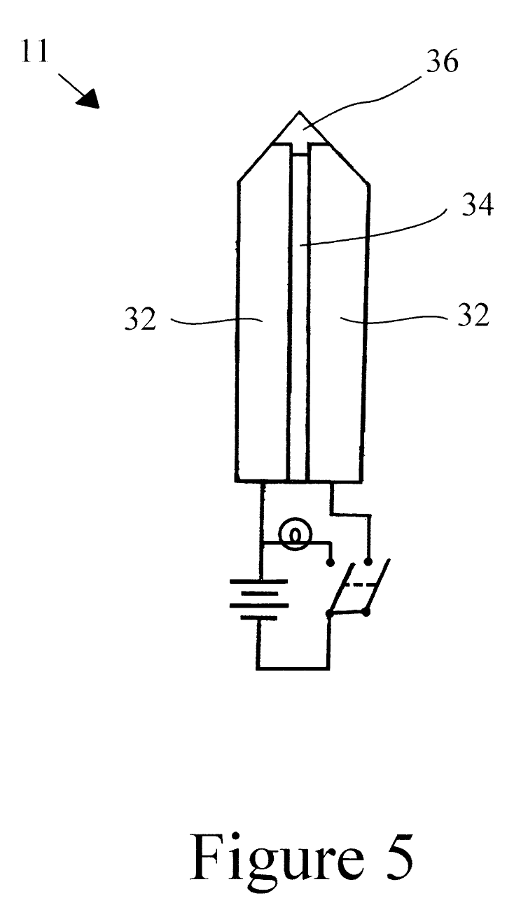

One notorious problem with athalite is that it is relatively brittle, which may cause the cutting tip to fracture if too much pressure is applied. FIG. 5 shows an embodiment wherein a metal conductive bridge 36 is provided to strengthen the heatable cutting tip 1. This conductive bridge may be bonded to the athalite with high temperature adhesives and firmly mounted by shortening the insulator 34 so as to form a socket in which the conductive bridge 36 sits.

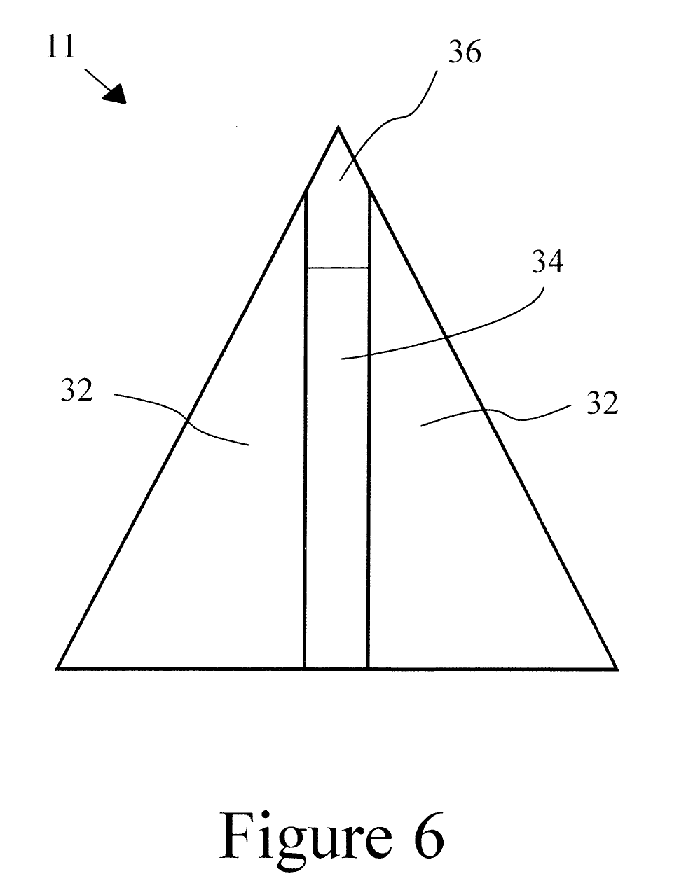

Referring to FIGS. 5 and 6, a pointed or blade-shaped athalite heatable cutting tip is provided with a shorted insulator 34 and a metal tip 36 inserted into the socket formed thereby. The idea in both FIGS. 5 and 6 is to transfer a portion of the pressure stresses to the insulator 34.

While various values, scalar and otherwise, may be disclosed herein, it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicates the latter to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will not be used to interpret or to limit the scope or the meaning of the claims.

What is claimed is:

1. A tool for opening blister packs, comprising:
a casing for handheld operation;
a heatable cutting tip;
a heating element in electrical contact with a power supply capable of bringing the operating temperature of the heating tip to no less than 380° F.; and
wherein the heating tip is configured to cut through the blister pack when heated to operating temperature.

2. The apparatus of claim 1 wherein the heating tip comprises a blade.

3. The apparatus of claim 1 wherein the heating element comprises a positive temperature coefficient element.

4. The apparatus of claim 1 wherein the heatable cutting tip is retractable.

5. The apparatus of claim 1 wherein the heating element comprises a positive temperature coefficient ceramic element sandwiched between a pair of electrodes that closely fit to the shape of the heatable cutting tip.

6. The apparatus of claim 1 wherein the heatable cutting tip comprises athalite.

7. The apparatus of claim 1 wherein the heatable cutting tip comprises a conductive bridge in electrical contact with a pair of athalite electrodes.

8. The apparatus of claim 7 wherein the conductive bridge comprises a metal.

9. The apparatus of claim 8 wherein the conductive bridge is an acute structure selected from a pointed or wedge shape.

10. The use of the apparatus of claim 1 to open a blister pack.

11. A method of opening blister packs, comprising the steps of: heating a cutting tip to a temperature of at least 380° F., and applying the cutting tip to a blister pack.
